(19) United States
(12) Patent Application Publication
(10) Pub. No.: US 2015/0217719 A1
(43) Pub. Date: Aug. 6, 2015

(54) AIRBAG MODULE FOR PEDESTRIAN PROTECTION

(71) Applicant: GM GLOBAL TECHNOLOGY OPERATIONS LLC, Detroit, MI (US)

(72) Inventor: Stephane Vitet, Frankfurt am Main (DE)

(21) Appl. No.: 14/610,953

(22) Filed: Jan. 30, 2015

(30) Foreign Application Priority Data
Jan. 31, 2014 (DE) 102014001305.7

(51) Int. Cl. B60R 21/36

(52) U.S. Cl. CPC B60R 21/36

(57) ABSTRACT

An airbag module is disclosed for protecting a pedestrian during a collision with a vehicle. The airbag module includes at least one connecting section for installing the airbag module in the area of a front hood and two opposing flat sides. One flat side faces the front hood with the airbag module installed. The airbag module includes an inflatable cushion and a gas generator for inflating the cushion between the flat sides. The cushion and gas generator lie one behind the other in the direction in which at least one of the flat sides extends. The flat sides may be designed symmetrically to each other in relation to a plane lying between the flat sides.

### CROSS REFERENCE TO RELATED APPLICATION

This application claims priority to German Patent Application No. DE 102014001305.7 filed Jan. 31, 2014, which is incorporated herein by reference in its entirety.

### TECHNICAL FIELD

The present disclosure relates to an airbag module for protecting a pedestrian during a collision with a vehicle.

### BACKGROUND

Apart from airbags for protecting passengers, some motor vehicles now include airbags that offer an effective impact protection during a collision with a pedestrian. In case of a collision, the unfolded cushion of the airbag covers areas of the vehicle which the pedestrian would hit during a collision. For example, the airbag modules are situated in the area of the front hood of a motor vehicle, so that when an airbag is deployed, the cushions unfold in the direction of the A-pillars as well as the lower area of the front windshield, thereby providing a pedestrian with effective impact protection. It turns out that the measures previously implemented to afford pedestrians protection during a collision take up a relatively large amount of space, and thereby make installation underneath the front hood of a motor vehicle more difficult. It also turns out that effective pedestrian protection is relatively costly, since previous airbag systems are technically complex and expensive.

### SUMMARY

Therefore, the present disclosure proposes a device that enables a cost-effective protection for a pedestrian in the event of a collision with a vehicle. At the same time, the device is to be compact in design prior to its activation, thereby enabling a space-saving accommodation, for example in the area underneath the front hood of a vehicle.

An airbag module for protecting a pedestrian during a collision with a vehicle has two opposing flat sides and at least one connecting section for installing the airbag module in the area of a vehicle component in such a way that one of the flat sides faces or abuts against the vehicle component. For example, the vehicle component can be a front hood, so that, in the installed state or in the installed position of the airbag module, one of the flat sides or the one of the flat sides faces the front hood, for example the bottom side of the front hood. The flat sides can include an essentially flat surface or consist thereof The flat sides can also contain a curved surface or consist thereof In particular, at least one of the flat sides can include a contour that essentially corresponds to the front hood in the installation area.

It is provided that an inflatable cushion and a gas generator for inflating the cushion are arranged between the flat sides. In particular, the cushion is located between the flat sides in a packed state when the cushion is, for example, folded. It is further provided that the cushion and gas generator lie one behind the other in the direction in which at least one of the flat sides extends. Additionally or alternatively, it is provided that the cushion and gas generator lie one behind the other in the direction of an axis lying in a plane that runs spaced apart from one of the flat sides.

As a result, the airbag module is realized with a compact overall size prior to its activation. In particular, the airbag module can be realized with a relatively slight distance between the flat sides, and hence in a flat manner. The airbag module is especially suitable for installation in the bottom side of the front hood of a vehicle, in particular since the airbag module has a compact design in the direction toward the interior of the motor vehicle lying underneath the front hood.

It is favorable beyond that for installation to take place on the left-hand side and also on the right-hand side in the area of the vehicle component, for example the front hood, since use can be made of identically designed airbag modules of the kind described above. This avoids the unfavorable installation situation in which the gas generator lies above the cushion given an installation on the right-hand side, and the gas generator lies under the cushion given an installation on the left-hand side, for example. By using just a single airbag module design, a collision protection means for a pedestrian can be inexpensively realized.

Additionally or alternatively, it is provided that the flat sides are designed symmetrically to each other in relation to a plane lying between the flat sides. This plane can be the plane described above.

This makes it easy to manufacture the airbag module. There are also advantages in terms of installing the airbag module, which can be brought into an installation position both with the one flat side and with the other flat side, facing in the direction of the vehicle component, in particular made to abut against the vehicle component.

Using an airbag module with such a design makes sense especially if the vehicle requires at least two airbag modules for pedestrian protection, and the airbag modules must be secured to areas of a vehicle component that are geometrically identical or essentially identical to each other. Identically designed airbag modules of the kind described above can then be used. For example, this facilitates an installation on the left-hand side and also on the right-hand side in the area of the front hood.

An especially compact structural design of the airbag module is achieved in one embodiment by having the plane run essentially parallel to at least one of the flat sides. For example, the plane can include the central plane between the flat sides.

An embodiment in which the gas generator with a central axis and the cushion with a central axis lie in the plane is also geared toward achieving a compact structural design. Because the plane forms the central plane between the flat sides, and the gas generator and cushion each lie with a central axis in the plane, the airbag module includes a geometrically simple shape when installed, which is easy and cost-effective to realize, and can be readily accommodated, for example in the area of the front hood of a motor vehicle.

An embodiment provides that the at least one connecting section lies in the plane, in particular the central plane. As a result, the airbag module can be flexibly installed. The airbag module can be easily built in with its one flat side facing in the direction of the vehicle component, as well as with its other flat side facing in the direction of the vehicle component.

In another embodiment, this type of installation is facilitated in particular by providing at least two connecting sections, which laterally protrude opposite each other from the airbag module, and each lie in the plane.

It is also conceivable that the at least one connecting section extend orthogonally to the plane. The airbag module can be flexibly installed in this case as well. In like manner, the airbag module can be easily built in with its one flat side facing in the direction of the vehicle component, as well as with its other flat side facing in the direction of the vehicle component, in particular when two such connecting elements are provided, which together lie in a plane situated orthogonally to the plane.

The flat sides can be formed by external sides of a housing, for example which incorporates the gas generator and cushion. The connecting section or connecting sections can be secured to the housing, in particular molded thereto, and protrude from the housing, for example.

Another embodiment provides that the airbag module includes an opening, which is situated in such a way that, when the airbag module is activated, the cushion exits the opening essentially in a direction along one of the flat sides. This facilitates the deployment of the cushion in the event of a crash, so that the cushion can rapidly and specifically unfold into those areas of the motor vehicle against which the impacted pedestrian is to be protected. For example, the opening can be arranged on a side in between the surfaces, in particular a narrow side.

The compact structural design of the airbag module is facilitated in one embodiment by situating the opening in such a way that the direction in which the cushion exits runs essentially in the direction in which the at least one flat side extends, along which the gas generator and cushion lie one behind the other.

For example, the opening can be situated in such a way that the direction in which the cushion exits runs essentially transverse to the direction in which the at least one flat side extends, along which the gas generator and cushion lie one behind the other. In particular, the direction in which the cushion exits runs essentially transverse to the direction of the axis, along which the gas generator and cushion lie one behind the other, and essentially lies in the plane in which the axis is located.

Another embodiment provides that the cushion has an L-shape when inflated. As a result, the cushion is specifically already designed with a shape which, once the airbag module is activated, can cover the areas of a motor vehicle that are especially affected, which impact the pedestrian in the event of a collision. The L-shape thus realizes a geometry that is especially effective during a crash at a relatively low material usage for the cushion. The relatively low material usage yields cost advantages. This measure also helps to reduce the weight of the entire airbag module.

For example, one embodiment involves having the cushion include the kind of L-shape when inflated in which one leg of the L-shaped cushion can cover an A-pillar, and the other leg can cover a section of the windshield, in particular a lower section of the windshield.

An airbag system encompassed by the present disclosure for protecting a pedestrian during a collision with a vehicle includes at least two airbag modules, each with an inflatable cushion and a gas generator for inflating the cushion. In particular, the airbag system includes at least two airbag modules, which have an identical structural design. The respective airbag module can be an airbag module of the kind described above.

In one embodiment of the airbag system, the airbag modules are arranged in the area of the front hood of a vehicle, so that when inflated, they cover the A-pillars and at least partially a section of the windshield of the vehicle, in particular a lower section. As a result, if a pedestrian hits the vehicle and the airbag system is triggered, the relevant areas of the motor vehicle are covered by the cushions, thereby effectively protecting the pedestrian.

The airbag system can be realized in a technically simple manner in one embodiment by situating the airbag modules in the area of the front hood of a vehicle in such a way that, once inflated, the cushions of the airbag modules lie essentially axially symmetrical in relation to the bisector of the windshield of the vehicle in the longitudinal direction of the vehicle. This mirror-imaged arrangement of airbags relative to each other especially facilitates the use of two airbag modules with the same design. As a consequence, the airbag modules can be realized as identical parts. Installation can take place in such a way that the airbag modules face each other. This makes it especially cost-effective to realize the airbag system. This also simplifies the assembly of the airbag system, since the same respective assembly steps are to be implemented for both the one airbag module and the other airbag module.

In addition, the present disclosure encompasses a front hood for a motor vehicle. Such a front hood has at least one airbag system of the kind described above, specifically with two airbag modules of the kind described above, in particular at least two airbag modules of the kind described above that are structurally identical to each other. An embodiment can provide that the airbag modules be located underneath the front hood. For example, the airbag modules can be laterally situated, for example by arranging one of the airbag modules on the left-hand side and the other airbag module on the right-hand side in the area of the front hood, e.g., underneath the front hood. Also possible is to situate the airbag modules in the area of the front hood, in particular underneath the front hood, which faces the windshield of the vehicle.

It is conceivable to mount the airbag modules on the lower side of the front hood. This allows a mechanic to easily and quickly secure the airbag modules to the front hood.

It can also be provided that the airbag modules are situated inside a hollow space formed on the lower side of the front hood. The hollow space can be formed by a reinforcing structure, for example, which is continuously situated on the lower side of the front hood, and serves to reinforce or stiffen the front hood, for example.

By incorporating the airbag modules inside the hollow space, they are brought into a protected location, and thereby protected against disruptive effects from outside, for example mechanical disruptive influences.

It makes sense for the airbag modules to be secured with one of the flat sides on the lower side or with one of the flat sides facing the lower side. As a result, the airbag modules are compactly situated in the direction of the normal of the front hood, so that the airbag modules in the vehicle only project slightly into the space underneath the motor hood, or not at all.

To the extent that the airbag modules are arranged inside the hollow space of a continuous reinforcing structure, and the reinforcing structure runs angularly, for example at least in the area of the airbag modules, the airbag modules can correspondingly include an angular outer contour, or be present in a correspondingly angular-shaped housing of the airbag module.

The present disclosure further encompasses a motor vehicle with at least one airbag module of the kind described above and/or with an airbag system of the kind described above and/or with a front hood of the kind described above.

The present disclosure proposes an airbag module and airbag system having a flat structural design. Furthermore, the airbag modules are suitable both installation on both the left-hand side and right-hand side of a motor vehicle. Weight can be economized The cost outlay is also reduced through the high level of component integration achieved by the present disclosure. The assembly process is also simplified. In addition, the present disclosure results in an improved kinematics during airbag deployment.

### BRIEF DESCRIPTION OF THE DRAWINGS

The present disclosure will hereinafter be described in conjunction with the following drawing figures, wherein like numerals denote like elements.

FIG. 1 is a perspective side view depicting an embodiment of an airbag system built into a vehicle for protecting a pedestrian during a collision with a vehicle, wherein the airbag system has already been activated;

FIG. 2 is a sectional view depicting an embodiment of an airbag module for the airbag system according to FIG. 1, with cushions folded together;

FIG. 3 is a sectional view depicting the airbag module according to FIG. 2 after its activation;

FIG. 4 is a perspective view depicting an embodiment of an airbag module for an airbag system according to FIG. 1;

FIG. 5 is a side view depicting the airbag module according to FIG. 4;

FIG. 6 is a front hood for a motor vehicle with an airbag system mounted thereto, viewed from below against the front hood;

FIG. 7 is a perspective view depicting an embodiment of an airbag module;

FIG. 8 is an embodiment of a front hood with an airbag system mounted thereto, viewed from below against the front hood;

FIG. 9 is an embodiment of a front hood with an airbag system mounted thereto, viewed from below against the front hood; and

FIG. 10 is a perspective view depicting an embodiment of an airbag module for an airbag system according to FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

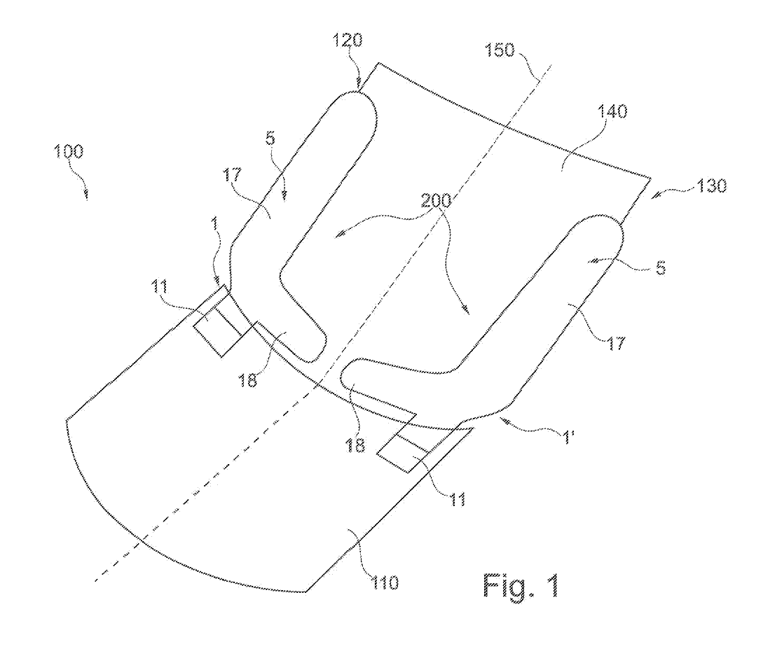

FIG. 1 presents a schematic view depicting an embodiment of an airbag system 200, which is integrated into a motor vehicle 100 and serves to protect a pedestrian during a collision with the vehicle 100. For simplification purposes, the vehicle 100 on FIG. 1 is denoted essentially by its front hood 110 and windshield 140, as well as by A-pillars 120 and 130 running laterally to the windshield 140.

The airbag system 200 includes two airbag modules 1 and 1′, which each have an inflatable cushion 5 and a (not shown on FIG. 1) gas generator for inflating the accompanying cushion 5. Before the airbag system 200 is activated, the gas generator is packaged or folded together in a storage space together with the accompanying gas generator. The storage space is marked with reference number 11 on FIG. 1. The storage space may also include a housing, which incorporates the gas generator along with the folded together cushion 5. To make the airbag system 200 more comprehensible, the storage spaces 11 for the respective airbag module 1 or 1′ are shown lying over the front hood 110 on FIG. 1 for the sake of simplicity, wherein the storage spaces 11 preferably lie underneath the front hood 110, for example on the lower side of the front hood 110, or in the area of the [front] hood 110.

The storage space 11 is preferably situated in the area of one side of the front hood 110, wherein the cushion 5 of the respective airbag module 1 or 1′ is preferably filled by the accompanying gas generator. It is basically also possible that the cushions 5 of the airbag module 1 and 1′ be filled by a shared gas generator. The airbag modules 1 and 1′ are preferably structurally identical airbag modules, which in the embodiment according to FIG. 1 are mirror-inverted in relation to each other.

FIG. 1 shows the airbag modules 1 and 1′ in an activated state, in which the respective cushion 5 has unfolded, and thus exerts a protective function for a pedestrian, in that it protects pedestrians against vehicle components as they hit the vehicle 100. When inflated, the respective cushion 5 includes an L-shape, wherein one leg 17 of the L-shaped cushion 5 covers the respectively accompanying A-pillar 120 or 130, while the other leg 18 of the respective L-shaped cushion 5 covers a lower section of the windshield 140. The airbag modules 1 and 1′ are situated axially symmetrical relative to the bisector 150 of the windshield 140 extending in the longitudinal direction of the vehicle. The inflated cushions 5 here together form an essentially U-shaped contour, wherein the legs 18 of the airbag modules 1 and 1′ leave a free space in the lower area of the windshield 140, for example in the area of the bisector 150. It can also be provided that the cushions 5 of the airbag modules 1 and 1′ be designed in such a way that, with the cushions 5 inflated, the legs 18 come to abut against each other when the cushions 5 are inflated.

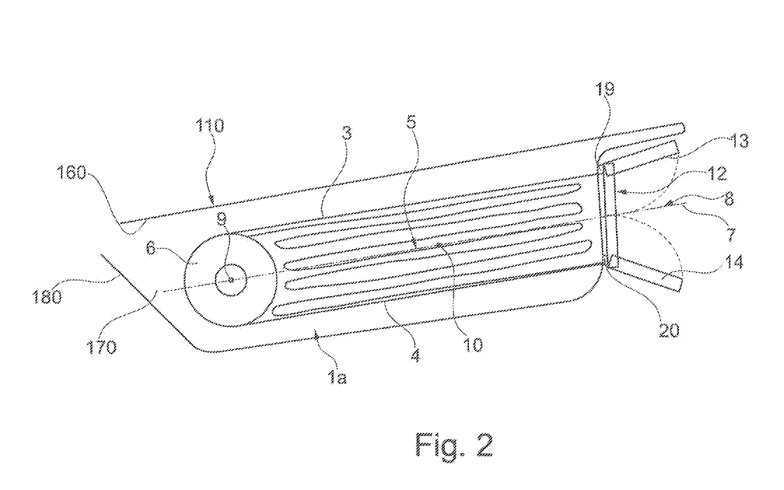

FIG. 2 shows an embodiment of an airbag module 1a, for example which can include the airbag module 1 or 1′ of the airbag system 200 according to FIG. 1. As depicted on FIG. 2, the cushion 5 of the airbag module 1a is packaged, wherein the cushion 5 can be folded, for example. The cushion 5 is inflated by a gas generator 6, wherein the gas generator 6 and cushion 5 form a compact unit in the initial state according to FIG. 2, which is bounded by two opposing flat sides 3 and 4. The cushion 5 and gas generator 6 are here situated lying one behind the other in the direction of an axis 7, which lies in a plane 8 that runs spaced apart from the flat sides 3 and 4. The plane 8 can essentially run parallel to at least one of the flat sides 3 and 4, wherein the plane preferably forms the central plane between the flat sides 3 and 4, and the gas generator 6 and cushion 5 each lie with a central axis 9 and 10 in the plane 8. This gives the airbag module 1 a compact structural design, and makes it suitable for installation both on the left-hand side and for installation on the right-hand side in the area of the front hood 110. To this end, the airbag module 1a only has to be turned to bring it from its one installation position, for example in which the flat side 3 faces the lower side of the front hood 110, into the other installation position, in which the flat side 4 then faces the lower side of the front hood 110.

The airbag module la can be situated in a hollow space 170, which is formed by a reinforcing structure 180 arranged on the lower side 160 of the front hood 110, for example. The reinforcing structure 180 can include an opening 12 on the side facing the windshield 140, for example, which can be closed by at least one closing means 13 or 14. The at least one closing means 13 or 14 can include two pivoting flaps, which can be swiveled outwardly. For example, the flaps can each includes a swiveling axis 19 and 20, which lies in a plane, for example, that lies essentially parallel to the plane 8 with the axis 7 and/or essentially parallel to at least one of the flat sides 3 and 4. When the airbag module 1a is activated, this causes the flaps 13 to 14 to outwardly open, wherein the one flap 13 is swiveled against the lower side 160 of the front hood 110, and the other flap 14 swivels in the opposite direction. The respective flaps or closing means 13 and 14 can be provided with sealing means, so as to tightly seal the opening 12 in the closed state.

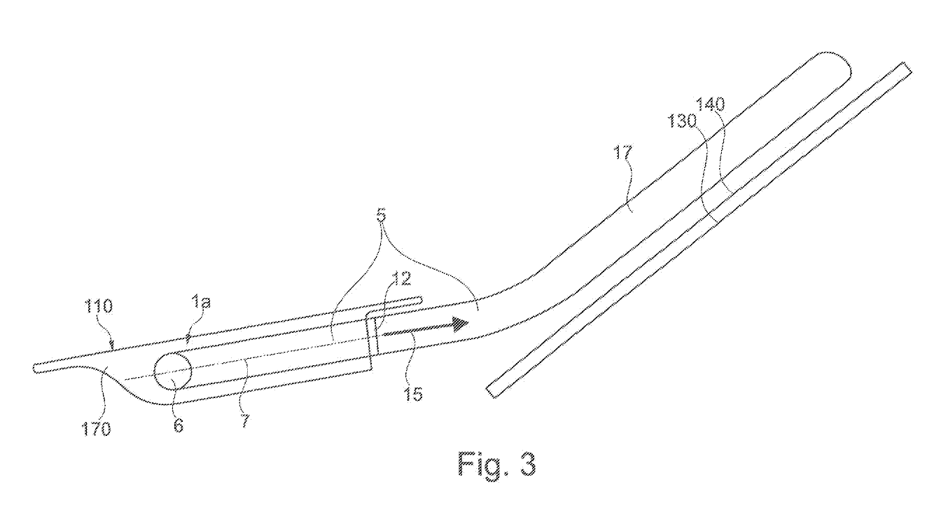

FIG. 3 presents a sectional view of the airbag module 1a, wherein the cushion 5 is there unfolded, and covers the lateral edge of the windshield 140 and accompanying A-pillar 130 with the leg 17. As evident from FIG. 3, the opening 12 is situated in such a way that, when the airbag module is activated, the cushion 5 unfolds in a direction 15, wherein this unfolding direction 15 essentially runs in the direction of the axis 7, along which the gas generator 6 and packaged cushion 5 lie one behind the other.

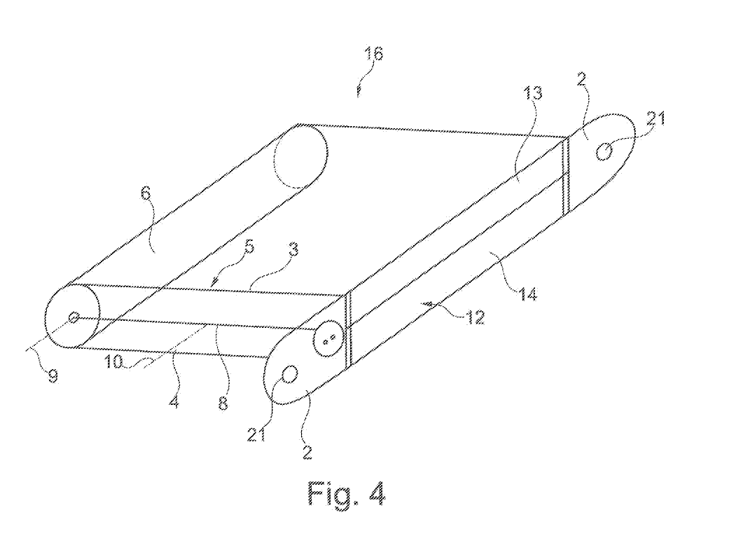

FIG. 4 shows an embodiment of an airbag module 1b. Components of the airbag module 1, 1′ according to FIG. 1 or the airbag module 1a according to FIGS. 2 and 3 that are identical or functionally the same as the components of airbag module 1b according to FIG. 4 are marked with the same reference numbers; in this regard, reference is made to the description for FIGS. 1 to 3.

The airbag module 1b according to FIG. 4 includes at least two connecting sections 2 lying on the outside, which make it possible to secure the airbag module 1b to a vehicle (not shown on FIG. 4), for example in the area of its front hood. The connecting sections 2 can be designed as flange sections, which each protrude laterally outward from the airbag module 1b. For example, the opening 12 can lie between the connecting sections 2, and be sealed with the sealing means 13 or 14.

The connecting sections 2 can each includes at least one through opening 21, so that connecting means can be used to secure, in particular bolt, the airbag 1b module thereto, for example against a component of the vehicle, e.g., in the area of the front hood.

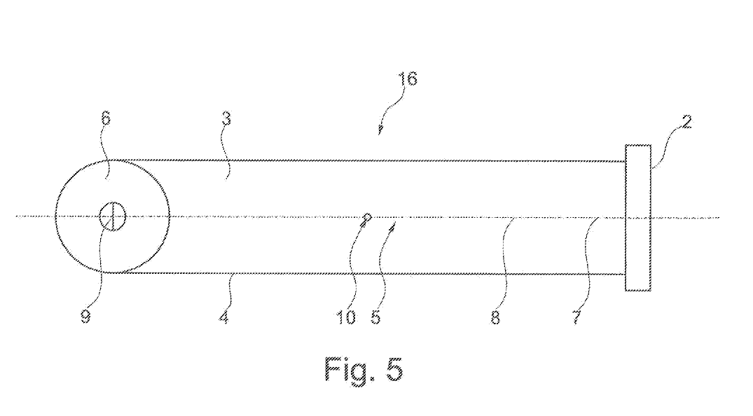

FIG. 5 presents a sectional view depicting the arrangement of the gas generator 6 as well as the cushion with the airbag module lb stowed, and the connecting section 2. As evident from the latter, the gas generator 6 and cushion 5 are situated one behind the other relative to the axis 7, which lies in the plane 8.

The central axis 9 of the gas generator 5 and central axis 10 of the cushion 5 preferably lie in the plane 8, wherein the plane 8 preferably includes the central plane between the flat sides 3 and 4.

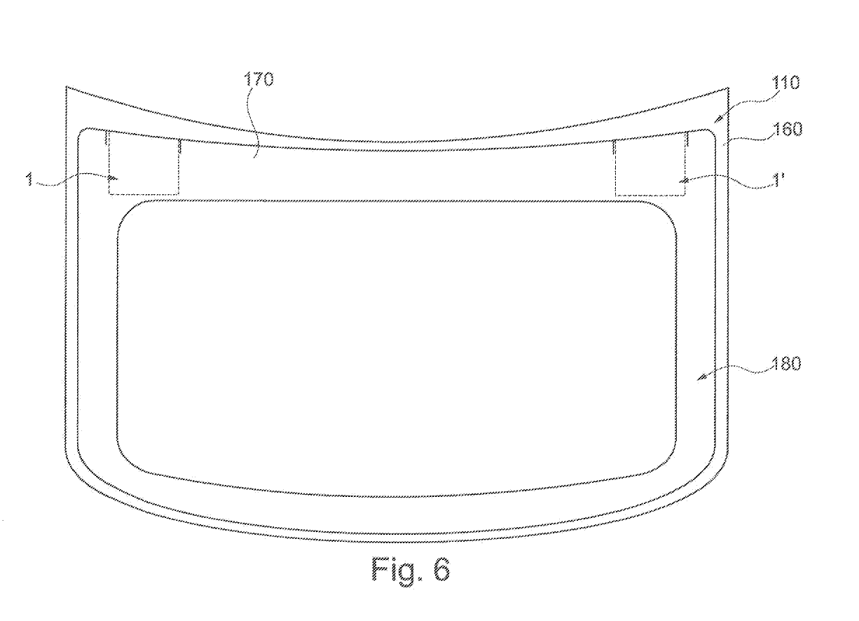

FIG. 6 presents a lower view depicting the front hood 110, which is equipped with the reinforcing structure 180. The reinforcing structure 180 is there designed as an essentially continuous ring, which runs along the edge area of the front hold 110 on its lower side 160, and forms a hollow structure. Dashed lines on FIG. 6 denote the installation site for the airbag modules 1 and 1′ of the airbag system 200 according to FIG. 1. The airbag modules 1 and 1′ are there accommodated in the hollow space 170 of the reinforcing structure 180. Of course, the airbag modules la and lb according to FIGS. 2 and 4 can also be accommodated there instead of airbag modules 1 and 1′.

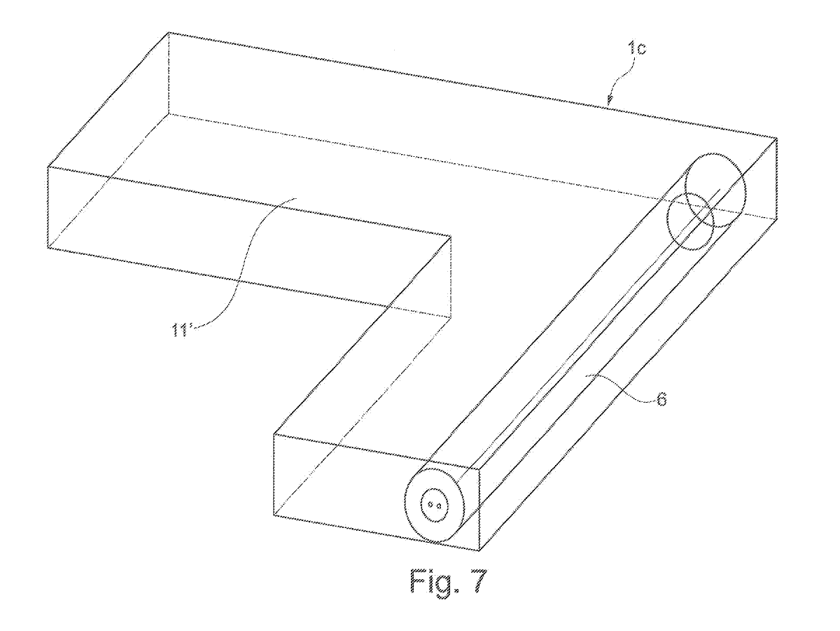

FIG. 7 shows an embodiment of an airbag module 1c. The airbag module 1c includes a housing 11′, in which the gas generator 6 is accommodated, and the cushion 5 can also be accommodated. The housing 11′ of the airbag module 1c resembles a kind of angle, in particular a flat angle, wherein the gas generator 6 extends along a leg on the external side.

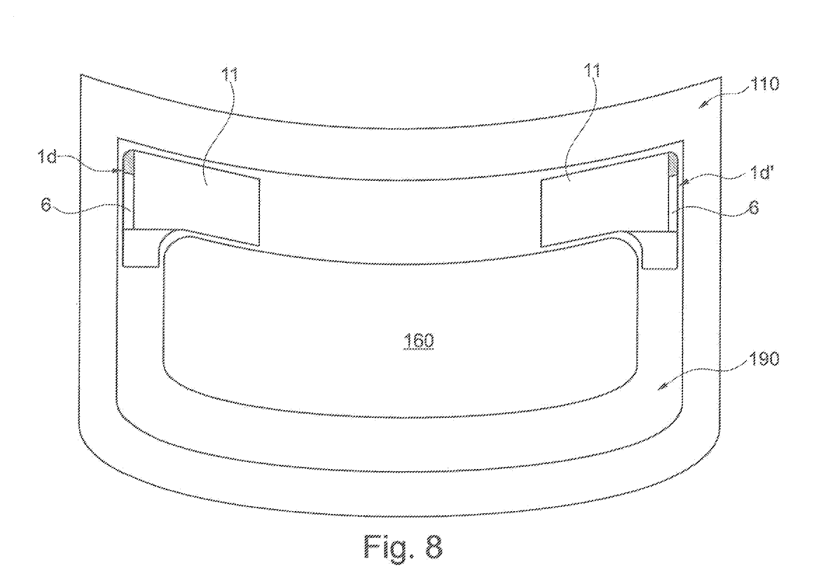

FIG. 8 shows one way of installing the airbag module 1c according to FIG. 7 in the area of the front hood 110. Situated on its lower side 160 is a reinforcing structure 190, which is continuous, and the reinforcing structure 190 includes an essentially angular transition from one side to the adjoining side on the side facing the windshield (not shown on FIG. 8). A respective airbag module 1d or 1d′ is mounted in the area of this angular transition, for example which can be structurally identical to the embodiment of the airbag module 1c on FIG. 7. The angular housing 11′ of the airbag module 1d or 1d′ is arranged on the respective angular contour of the reinforcing structure 190. It is preferred that the angular shape of the housing 11′ be essentially adjusted to the contour of the reinforcing structure 190 in the area of the installation site for the airbag module 1d or 1d′.

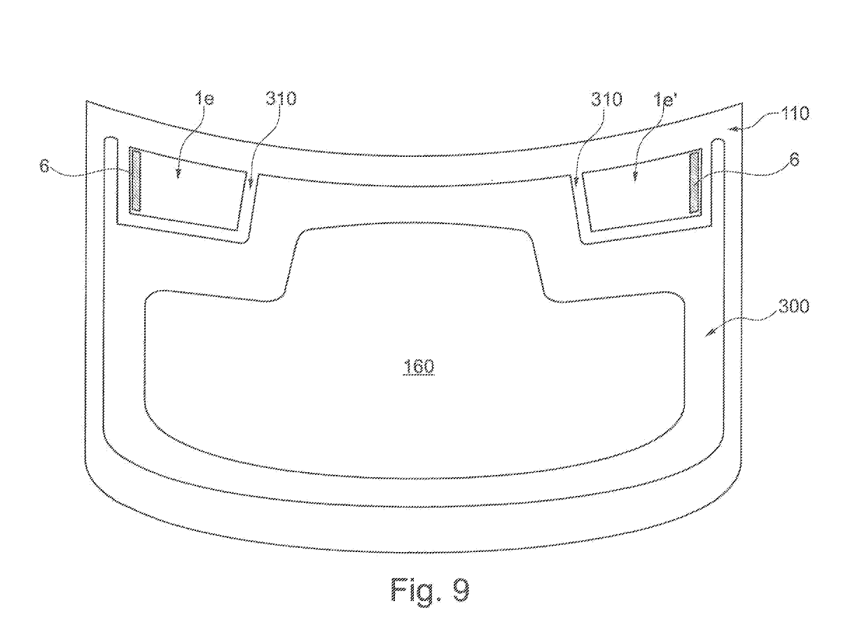

FIG. 9 shows the front hood 110 with another embodiment of a reinforcing structure 300, which is continuous in design. Situated on the lower side 160 of the front hood 110 is an embodiment of an airbag module 1e and 1e′, wherein the installation site 310 for the airbag modules 1e and 1e′ lies outside the reinforcing structure 300. The reinforcing structure 300 runs around the installation site 310.

As further evident from FIG. 9, the gas generator 6 for airbag modules 1e and 1e′ runs in the direction of the laterally external side of the front hood 110. To this end, for example, the gas generator 6 is located on the respective exterior of the airbag module 1 or 1c′, with its longitudinal axis running essentially parallel to the lateral external side of the front hood 110.

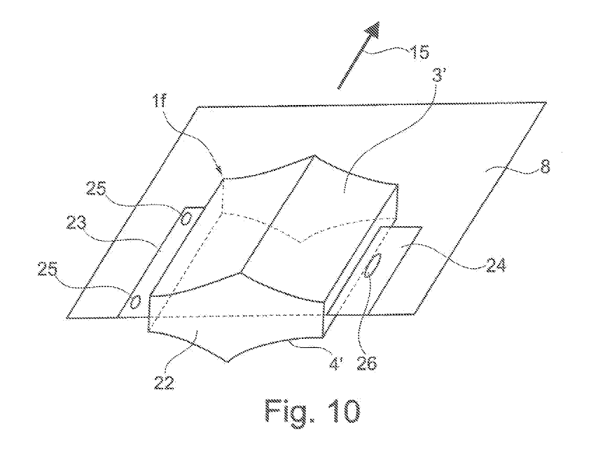

FIG. 10 shows an embodiment of an airbag module 1f, for example which can form the airbag module 1 or 1′ of the airbag system 200 according to FIG. 1. Components of the airbag module 1f that are identical or functionally the same as the components of the above airbag modules are marked with the same reference numbers; in this regard, reference is made to the description to the above figures.

The airbag module 1f has two opposing flat sides 3′ and 4′, between which are situated an inflatable cushion (not shown on FIG. 10) and a gas generator for inflating the cushion (not shown on FIG. 10). The airbag module if further includes at least one, preferably two connecting sections 23, 24 for installing the airbag module 1f in the area of a vehicle component (not shown on FIG. 10), for example a front hood, in such a way that one of the flat sides 3′, 4′ faces or abuts against the vehicle component.

The flat sides 3′ and 4′ are designed symmetrically to each other in relation to a plane lying between the flat sides 3′ and 4′, specifically the plane 8 already described above, which is preferably the central plane. For example, the flat sides 3′ and 4′ include a contour corresponding to the vehicle component, which can have a curved design.

In particular, the flat slides 3′, 4′ include the external sides of a housing 22. Connecting sections 23, 24 can be secured, in particular molded, thereto. The connecting sections 23 and 24 each preferably lie in the plane 8, and laterally protrude outwardly from the housing 22, for example. The connecting sections 23 and 24 each include fastening points 25, 26. The fastening points 25 of the one connecting section 23 can be configured differently than the fastening points 26 of the other connecting section 24. It is also conceivable that the fastening points 25, 26 on the respective connecting section 23 or 24 be identically configured.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. An airbag module for protecting a pedestrian during a collision with a vehicle comprising:
a housing having two opposing flat sides and at least one connecting section configured to install the airbag module in the area of a vehicle component, wherein a first flat side is configured to face the vehicle component; and
an airbag assembly including an inflatable cushion and a gas generator for inflating the cushion arranged between the two flat sides, wherein the gas generator is arranged behind the inflatable cushion in the direction in which at least the first flat sides extends.

16. The airbag module according to claim 15, wherein the flat sides are symmetrical to each other in relation to a central plane lying between the flat sides, wherein comprising two opposing flat sides, between which are situated the inflatable cushion and the gas generator for inflating the cushion, and at least one connecting section configured to install the airbag module in an area of a vehicle component in such a way that a first flat side faces against the vehicle component.

17. The airbag module according to claim 15 wherein the housing further comprises an opening essentially in a direction along one of the flat sides for providing an exit for the cushion when the airbag module is activated.

18. The airbag module according to claim 15, the housing further comprises an opening situated in such a way that the direction in which the cushion exits runs essentially in the direction in which the at least one flat side extends, along which the gas generator and cushion lie one behind the other.

19. The airbag module according to claim 15, the housing further comprises an opening situated in such a way that the direction in which the cushion exits runs essentially transverse to the direction in which the at least one flat side extends, along which the gas generator and the cushion lie one behind the other.

20. The airbag module according to claim 15, wherein the cushion comprises an L-shape cushion when inflated.

21. The airbag module according to claim 20, wherein the L-shaped cushion comprises a first leg configured to cover an A-pillar, and a second leg configured to cover a portion of a windshield.

22. An airbag system for protecting a pedestrian during a collision with a vehicle, comprising at least two airbag modules, each air bag module comprising:
a housing having two opposing flat sides and at least one connecting section configured to install the airbag module in the area of a vehicle component, wherein a first flat side is configured to face the vehicle component; and
an airbag assembly including an inflatable cushion and a gas generator for inflating the cushion arranged between the two flat sides, wherein the gas generator is arranged behind the inflatable cushion in the direction in which at least the first flat sides extends.

23. The airbag system according to claim 22, wherein the airbag modules are situated in an area of a front hood of a vehicle, so that when inflated, the cushions of each airbag modules cover an associated A-pillar and at least a portion of a windshield of the vehicle.

24. The airbag system according to claim 23, wherein the airbag modules are situated in the area of the front hood of a vehicle in such a way that, when inflated, the cushions of the airbag modules lie essentially axially symmetrical in relation to a bisector of the windshield of the vehicle in a longitudinal direction of the vehicle.

25. A front hood for a motor vehicle comprising an airbag system according to claim 21.

26. The front hood according to claim 25, wherein the airbag modules are mounted underneath the front hood.

27. The front hood according to claim 26, wherein the airbag modules are mounted on the lower side of the front hood.

28. The front hood according to claim 27, wherein the airbag modules are situated inside a hollow space formed on the lower side of the front hood.

29. A motor vehicle having a front hood and further comprising the at least one airbag module according to claim 15 installed on the front hood.

30. A motor vehicle having a front hood and further comprising the airbag module according to claim 22 installed on the front hood.
